(19) United States
(12) Patent Application Publication
(10) Pub. No.: US 2011/0268547 A1
(43) Pub. Date: Nov. 3, 2011

(54) Robot gripper and manipulating robot

(76) Inventor: Fredy Doll, Achern (DE)

(21) Appl. No.: 13/066,876

(22) Filed: Apr. 27, 2011

(30) Foreign Application Priority Data
Apr. 28, 2010 (DE) 102010018966.9

(51) Int. Cl. B25J 9/00; B25J 15/00; B66F 9/02

(52) U.S. Cl. 414/661; 414/785; 901/27; 901/30; 901/2

(57) ABSTRACT

A robot gripper for grasping, transporting, and depositing goods in transit including a gripper base having a coupling device for attachment to a robot arm, a carrying device and a displacement device. The carrying device extends in the longitudinal direction of the gripper and a carrying surface serves to carry the object being transported and extends substantially in the longitudinal and transverse direction of the gripper. The displacement device is disposed above the carrying device in an upward vertical direction of the gripper and serves to apply force, in the longitudinal direction of the gripper, to the object being transported. The displacement device and the carrying device are each capable of being moved relative to the gripper base in the longitudinal direction of the gripper and of being moved concurrently and in opposite directions relative to the gripper base.

### FIELD OF APPLICATION AND PRIOR ART

This application claims the priority of the German patent application No. 10 2010 018 966.9. The whole disclosure of this prior application is herewith incorporated by reference into this application.

The invention relates to a robot gripper for grasping, transporting, and depositing goods in transit, more particularly pieces of baggage such as suitcases and traveling bags, as defined in the generic clause of Claim 1.

A generic robot gripper such as that disclosed in DE 10 2005 022 828 A1 comprises a gripper base, on which there is provided a coupling device for mounting the robot gripper on a robot arm. A generic robot gripper further comprises a carrying device including a carrying surface that serves for carrying the goods in transit and that extends substantially in the longitudinal and transverse directions of the gripper. The goods in transit lie on this carrying device during transportation thereof by means of the robot gripper, which carrying device is substantially oriented in the horizontal direction during operation. Furthermore, a generic robot gripper comprises a displacement device that is disposed above the carrying device in an upward vertical direction of the gripper and that serves to apply a force, in the longitudinal direction of the gripper, to the object being transported.

The generic robot gripper allows the object being transported that lies on the carrying surface of the carrying device to be removed from the same by means of the displacement device by causing relative movement to take place between the carrying device and the displacement device in the longitudinal direction of the gripper. As a result of this relative movement, the object being transported is pushed down from the carrying surface and can thus be placed, for example, on the floor of a freight container.

The problem in the design of a generic robot gripper is that the carrying surface must be of considerable length, preferably more than 40 cm, in the longitudinal direction of the gripper, for the purpose of picking up and depositing pieces of baggage of standard sizes. In order to make it possible to reliably remove the object being transported from the carrying surface, the relative displaceability between the displacement device and the carrying device must therefore be equally large. In order to achieve this in the case of a comparatively small and lightweight robot gripper, it is either necessary to move the components of the driving system for the relative displacement of the displacement device and the carrying device at least in stages in the longitudinal direction of the gripper to a position far behind the coupling device, where there is the risk of a collision with the robot arm, or use may be made of a telescopic mechanism such as a telescopic spindle or a telescopic carrying device. However, such a telescopic mechanism is very expensive and/or prone to faulty operation. Moreover, telescopic devices of adequate stability are frequently comparatively heavy in weight.

### OBJECT AND ITS ACHIEVEMENT

It is therefore an object of the invention to develop a generic robot gripper such that it has a simple and very lightweight construction and provides the necessary relative displaceability between the displacement device and the carrying device.

According to the invention, this object is achieved in that the displacement device and the carrying device are each capable of being moved relatively to the gripper base in the longitudinal direction of the gripper. The displacement device and the carrying device are configured to be moved concurrently and in opposite directions relatively to the gripper base.

This design, in which the carrying device and the displacement device are both movable relatively to the gripper base, makes it possible to keep down the maximum range of movement of each of the above devices relatively to the gripper base, since the maximum displaceability of the carrying device and the displacement device relatively to each other is defined by the sum of the displaceability of the carrying device, on the one hand, and that of the displacement device, on the other hand, relatively to the gripper base. Thus it is possible to achieve a compact robot gripper, the subcomponents of which need only be displaceable over a comparatively small distance relatively to the gripper base. Preferably, the carrying device and the displacement device are displaceable relatively to the robot base through approximately the same distance, in order to achieve a particularly compact construction of the robot gripper. A displaceability ratio of up to 2:1 is still within a range regarded as being very advantageous.

The displacement device and the carrying device jointly delimit the receiving area for the goods in transit, which will be carried by both devices, the displacement device delimiting the receiving area toward the rear in the longitudinal direction of the gripper, and the carrying device delimiting the receiving area toward the bottom of the robot gripper. The portion of the receiving area that can be used for the goods in transit carried thereby is thus determined by the position of the carrying device and the position of the displacement device, and only the cooperation of these two devices as proposed by the invention provides for the reduction of this useful area to a minimum.

Preferably, there are no portions on the gripper of the invention that extend into this receiving area above the displacement device so that the goods in transit are not restricted as regards height.

The displacement device of a generic robot gripper that is provided above the carrying device in a neutral position resembles a pusher capable of applying force to the side of the object being transported in order to push it off the carrying device. Furthermore, provision can be made for the displacement device to be configured so as to apply a force to the object being transported and carried by the carrying device, which force can be a negative pressure or a magnetic force acting in the direction of the displacement device and serving to facilitate lifting of said object from the flat underlying surface and/or to secure it more effectively on the carrying device.

A contact area disposed at the distal end of the displacement device, as regarded in the longitudinal direction of the gripper, comes into contact with the goods in transit in accordance with the designated use of the robot gripper and can be part of an intrinsically rigid displacement device. However, the contact area can alternatively have further degrees of freedom of movement in addition to its movability in the longitudinal direction of the gripper relatively to the gripper base. In particular, the contact area can be hinged to a main part of the displacement device capable of movement only in the longitudinal direction of the gripper so as to be capable of pivoting about a pivot axis extending in the transverse direction of the gripper.

The carrying device provides the carrying surface for the goods in transit. Preferably, the various parts of the carrying surface are unable to be moved relatively to each other, more particularly to be telescoped into each other in the longitudinal direction of the gripper. Instead, the carrying surface is preferably completely or substantially flat and can be moved only in its entirety for the purpose of allowing the object being transported to be picked up or deposited easily. In particular, it can be advantageous when the carrying device comprises a plurality of carrying prongs that extend in the longitudinal direction of the gripper and are spaced apart in the transverse direction of the gripper.

The following terms used in the context of this document are explained hereinafter and should be understood to mean as follows: the “upward vertical direction of the gripper” is defined by a normal to the carrying surface of the carrying device. The “longitudinal direction of the gripper” extends orthogonally to the upward vertical direction of the gripper in the direction in which the carrying device and the displacement device are capable of being moved relatively to each other. The “transverse direction of the gripper” extends orthogonally to the upward vertical and longitudinal directions of the gripper. The term “toward the front” denotes a direction starting from the gripper base in the longitudinal direction of the gripper to the distal end of the carrying device. The term “toward the rear” denotes the opposite direction. The terms “top” and “bottom” refer to the neutral position of the robot gripper in which the carrying device is oriented horizontally so that a piece of baggage can be carried thereby.

A robot gripper of the invention can comprise separate motors for moving the displacement device, on the one hand, and the carrying device on the other hand, relatively to the gripper base. For the purpose of unloading the object being transported, the separate motors can be controlled by a control unit such that the displacement device and the carrying device are moved in opposite directions relatively to each other. However, it is particularly advantageous when a transmission is provided by means of which forced mechanical coupling is achieved between the movement of the displacement device relatively to the gripper base, on the one hand, and the movement of the carrying device relatively to the gripper base, on the other hand. Such a transmission makes it possible to use only one motor to achieve such forced coupling of the two relative movements. As a result, it is possible to achieve a lightweight construction of the robot gripper. Such a transmission providing forced coupling may also include a drive comprising two subordinate transmissions that each couple an output shaft of a common motor to the movement of the displacement device, on the one hand, and of the carrying device, on the other. The transmission may involve hydraulic or pneumatic coupling of the carrying device and of the displacement device.

In a particularly advantageous embodiment, such a transmission comprises at least one driving wheel each for the displacement device and the carrying device. These driving wheels are preferably in the form of gearwheels that each cooperate with toothed racks disposed one on the displacement device and one on the carrying device and which extend in the longitudinal direction of the gripper. For the purpose of coupling the driving wheels, there is preferably provided a belt transmission, by means of which the driving wheels are coupled to each other and/or to a common driving motor. Such a belt transmission represents a lightweight and economical component of the transmission.

It is particularly advantageous when the displacement device is provided with a toothed rack, the teeth of which point upwardly in the vertical direction of the gripper and with which a gearwheel disposed above this toothed rack meshes, while provision is likewise made on the underside of the carrying device for a further toothed rack, the teeth of which point downwardly and with which a gearwheel disposed below this toothed rack in the vertical direction of the gripper meshes. In such an arrangement, the driving wheels can be driven in the same direction of rotation, for example by a belt transmission, while still achieving a movement of the carrying device and displacement device in opposite directions.

It is particularly advantageous when the displacement device and the carrying device are displaced at least to such an extent relatively to each other that, in a first relative end position, a distal end of the carrying device is disposed not more than 15 cm ahead of a distal end of the displacement device, as regarded in the longitudinal direction of the gripper. It is particularly advantageous when the displacement device and the carrying device are displaced to such an extent relatively to each other that the distal end of the displacement device protrudes in this state beyond the distal end of the carrying device, as regarded in the longitudinal direction of the gripper.

The first relative end position is understood to mean the position in which the displacement device has been moved, starting from the gripper base, as far as possible in the direction of the distal end of the robot gripper and in which the carrying device has been moved as far as possible in the opposite direction. In this first relative end position, the portion of the carrying surface of the carrying device that can be utilized by the goods in transit preferably has a maximum length of 15 cm, so that the center of gravity of pieces of baggage that are 30 cm long is usually no longer located above the carrying surface, so that these pieces of baggage can tip or slide down from the carrying surface in accordance with the designated use of the robot gripper. As a result of the ability of the displacement device to be displaced even beyond the distal end of the carrying device, it is possible to unload goods in transit of any desired size in a highly reliable manner.

In a second relative end position, which is contrary to the first relative end position and in which the carrying surface accordingly has a maximum useful length, the length of the carrying surface in the longitudinal direction of the gripper is preferably at least 25 cm, more preferably at least 35 cm and in the ideal case at least 45 cm. Thus pieces of baggage of standard sizes can be supported completely or almost completely on the carrying surface without the same protruding to any significant extent in the longitudinal direction of the gripper.

Furthermore, the invention relates to a robot system for grasping, transporting, and depositing goods in transit, more particularly pieces of baggage such as suitcases and traveling bags, which robot system comprises a robot base that is stationary or that can be displaced by means of a rail system, a robot arm which can be moved relatively to the robot base and at the end of which a coupling device is provided for coupling a robot gripper to the robot arm, and a control unit for controlling the robot arm and the robot gripper. According to the invention, provision is made for a robot gripper of the aforementioned type to be attached to the coupling device of the robot arm.

This robot gripper can be configured in the manner described above so as to comprise a transmission that provides for forced coupling between the movement of the displacement device relatively to the gripper base, on the one hand, and the movement of the carrying device relatively to the gripper base, on the other. In an embodiment in which separate drives are provided for the displacement device, on the one hand, and for the carrying device, on the other, the control unit is adapted to move these drives relatively to each other in an appropriate manner such that they are moved concurrently in opposite directions, in order to allow the object being transported to be unloaded in the manner described above. Preferably, the control unit is configured to diminish the relative displacement between the displacement device and the flat underlying surface onto which the object being transported is to be unloaded during such an unloading operation, more particularly to ensure that, during the unloading operation, the horizontal displacement of the displacement device relatively to the flat underlying surface is less than 10 cm in the horizontal direction. This is achieved in that, concurrently with the displacement of the displacement device and of the carrying device relatively to the gripper base, the gripper base is moved approximately to the same extent by means of the robot arm. The goods in transit are thus scarcely moved relatively to the flat underlying surface in the horizontal direction during the unloading operation, so that the goods in transit are not subjected to damage resulting from sliding against the flat underlying surface. Preferably, the robot gripper is positioned during the unloading operation so as to slope downwardly toward its distal end, so that the object being transported slides down from the carrying device instead of falling off the same.

### BRIEF DESCRIPTION OF THE DRAWINGS

Additional aspects and advantages of the invention are revealed in the claims and the following description of a preferred exemplary embodiment of the invention with reference to the drawings, in which:

FIG. 1 shows a robot gripper of the invention that is coupled to a robot arm,

FIG. 2 is a side view of the robot arm and the robot gripper in their entirety, and

FIGS. 3a to 3c illustrate the relative movements of the carrying device and the displacement device of the robot gripper in various stages of movement.

### DETAILED DESCRIPTION OF THE EXEMPLARY EMBODIMENT

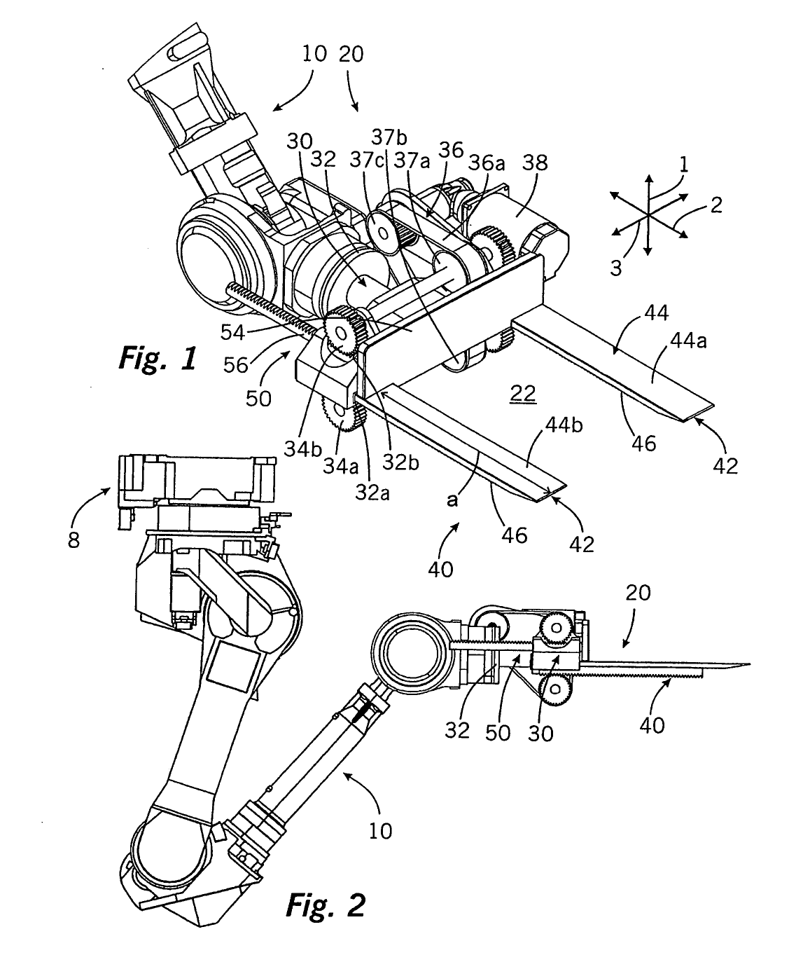

FIG. 1 shows a robot gripper 20 of the invention that is coupled to a robot arm 10. This robot gripper 20 serves to transport goods in transit, more particularly pieces of baggage, for the purpose of automated baggage manipulation, for example at an airport. For this purpose, the robot gripper 20 comprises a receiving area 22 for accommodating the goods in transit.

As regarded in the upward vertical direction 1 of the robot gripper, the bottom portion of this receiving area 22 is formed by the carrying surface 44 of a carrying device 40. This carrying device 40 has two carrying prongs 42 that extend in the longitudinal direction of the gripper and the top surfaces 44a, 44b of which jointly form the carrying surface 44.

The receiving area 22 is delimited by a contact surface 54 of a displacement device 50, which contact surface is disposed on that side of the receiving area 22 that is oriented toward the robot arm 10, as viewed in the longitudinal direction of the gripper.

Both the carrying device 40 and the displacement device 50 are capable of being moved in the longitudinal direction 2 of the gripper relatively to a gripper base 30 on which a coupling device 32 is provided for coupling the robot gripper to the robot arm 10.

For this purpose, the prongs 42 of the carrying device 40 are guided in guides 32a. Toothed racks 46 meshing with driving gearwheels 34a are provided on the underside of the prongs 42. Similarly, toothed racks 56 which extend in the direction of the robot arm 10 and which are guided in guides 32b of the gripper base 30 are provided on the displacement device 50 on both sides thereof. Driving gearwheels 34b likewise mesh with these toothed racks 56.

The driving gearwheels 34a and 34b are coupled to each other by means of a belt transmission 36 for the purpose of displacing the carrying device 40 and the displacement device 50 respectively. The toothed belt 36a of this belt transmission 36 wraps around cogged-belt sprocket wheels 37a, 37b that are connected to the driving gearwheels 34a and 34b so as to rotate therewith and a cogged-belt sprocket wheel 37c that can be driven by means of an electric motor 38.

This belt transmission 36 provided on the gripper base 30 causes the movement of the carrying device 40, on the one hand, to be coupled with that of the displacement device 50, on the other. Depending on the direction of rotation of the driving motor 38, the carrying device 40 and the displacement device 50 are always moved in opposite directions and in such a way that the receiving area 22 is either enlarged or reduced.

In the state shown in FIG. 1, the receiving area 22 is shown at its maximum size. The carrying region of the carrying prongs 42 that extends in the longitudinal direction 2 of the gripper and that is available for the object being transported and carried by the carrying prongs has a length a of about 50 cm in the longitudinal direction of the gripper in this state.

By virtue of the fact that both the carrying device 40 and the displacement device 50 are capable of being moved relatively to the gripper base 30, a reduction in the usable portion of the receiving area to a length of a=0 does not require a separate displacement of the carrying device 40 or of the displacement device 50 relatively to the gripper base 30 by a distance of 50 cm. Instead, it is sufficient when the sum of the movements of the carrying device 40 and displacement device 50 is equal to the length a. Thus, for example, it is sufficient to displace the carrying device and the displacement device each by a distance of about 25 cm relatively to the gripper base 30. Different displacement distances are alternatively possible when use is made of driving gearwheels 34a, 34b or other transmission configurations.

The size of the robot gripper 20 can be reduced very considerably as a result of the reduced displaceabilities of the carrying device and the displacement device. Furthermore, the toothed racks 56 of the displacement device 50 protrude only slightly beyond the coupling device 32 forming the wrist root point of the robot gripper 20 toward the rear in the direction of the robot arm 10 even in the relative end position shown in FIGS. 1 and 2, so that the freedom of movement of the robot arm 10 is scarcely restricted by the respective state of the robot gripper 20.

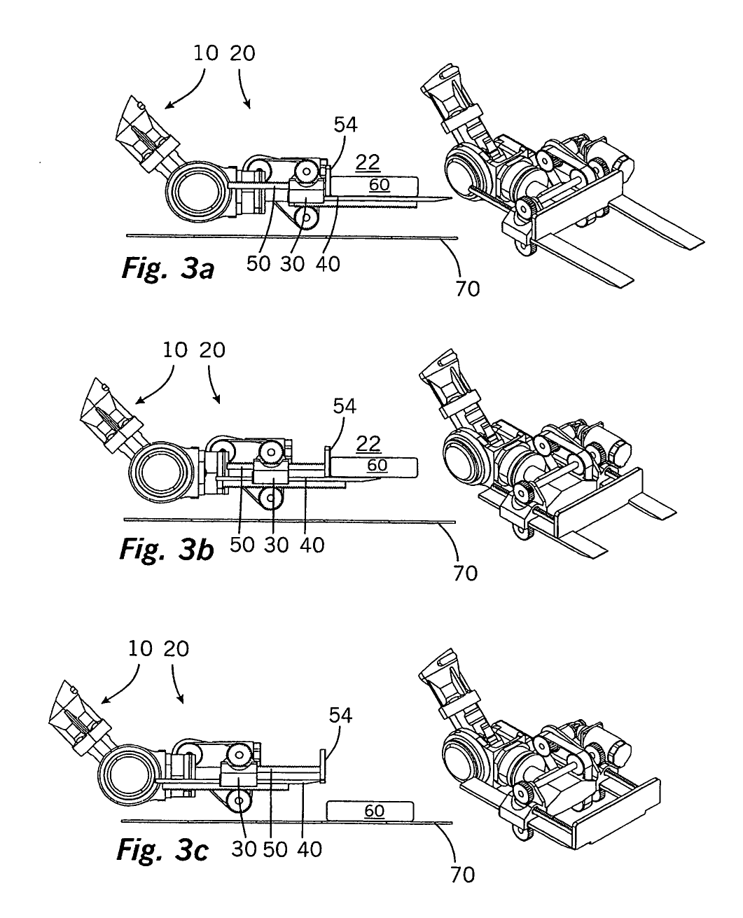

The aforementioned FIG. 2 shows the robot gripper 20 in a state in which it is coupled to the robot arm 10 shown in its entirety. The robot arm 10 is in turn pivotally mounted on a robot base 8, which can be attached permanently to a hall ceiling or a rail system. When pieces of baggage are loaded onto the receiving area 22 of the robot gripper 20 or unloaded therefrom, the robot arm 10, by virtue of its additional freedom of movement, allows the object being transported to achieve a predetermined position. This is explained with reference to FIGS. 3a to 3c.

FIGS. 3a to 3c each show the robot gripper 20 as a side view and a perspective view in three stages during unloading of an object in transit 60, such as a suitcase. In the state shown in FIG. 3a, the carrying device 40 and the displacement device 50 of the robot gripper 20 are in a position corresponding to that shown in FIG. 1. The piece of baggage 60 to be transported is disposed in the receiving area 22, which is enlarged to its maximum extent in this state.

To make it possible to unload said object onto the flat underlying surface 70, the carrying device 40 and the displacement device 50 are displaced concurrently relatively to the gripper base 30 above the depositing area by means of the electric motor 38. During these simultaneous movements, the displacement device 50 is moved to the right and the carrying device 40 to the left, as viewed according to the side views shown in FIGS. 3a to 3c. As a result, the receiving area 22 is reduced such that the object 60 being transported is moved increasingly farther to the right on the carrying device 40. However, the robot gripper 20 is simultaneously displaced in its entirety toward the left by means of the robot arm 10 so that the position of the contact surface 54 of the displacement device 50 remains approximately unchanged above the flat underlying surface 70. As a result of the carrying device and the displacement device 50 being displaced progressively relatively to the gripper base 30, the object being transported 60 is pushed increasingly farther from the carrying device 40 and the carrying prongs 42 thereof until the article being transported falls off the carrying device onto the flat underlying surface 70. In doing so, the suitcase is moved substantially in the vertical direction and scarcely in the horizontal direction relatively to the flat underlying surface.

The procedure of depositing the object being transported as described above is illustrated in a simplified form. It is advantageous when the right-hand end of the robot gripper 20, as viewed according to the side view shown in FIGS. 3a to 3c, is lowered toward the front during the unloading operation so that the suitcase 60 does not fall off the carrying device, but instead slowly slides down from the same and makes contact with the flat underlying surface with the center of gravity still being located above the carrying device 40.

Although built with comparatively small external dimensions, the robot gripper of the invention is capable of effecting a comparatively large displacement of the displacement device 50 relatively to the carrying device 40 so that the robot gripper is suitable for receiving very large articles to be transported, more particularly large pieces of baggage, while it still makes it possible to reduce the size of the receiving area 22 to zero, as shown in FIG. 3c.

1. A robot gripper (20) for gripping, transporting, and depositing goods in transit (60), more particularly pieces of baggage such as suitcases and traveling bags, comprising
a gripper base (30) with a coupling device (32) for attachment to a robot arm (10),
a carrying device (40) extending in a longitudinal direction (2) of said gripper and having a carrying surface (44) serving to carry the object in transit (60) and extending substantially in the longitudinal direction (2) of said gripper and in a transverse direction (3) of said gripper,
a displacement device (50) which is disposed in an upward vertical direction (1) of said gripper above said carrying device (40) and serves to apply force to said object in transit (60) in the longitudinal direction (2) of said gripper,
characterized in that
said displacement device (50) and said carrying device (40) are each capable of being moved in the longitudinal direction (2) of said gripper relatively to said gripper base (30) and
said displacement device (50) and said carrying device (40) are adapted to be concurrently moved in opposite directions relatively to said gripper base (30).

2. The robot gripper as defined in claim 1,
characterized by
a transmission (36) by means of which a forced mechanical coupling is established between the movement of said displacement device (50) relatively to said gripper base (30), on the one hand, and the movement of said carrying device (40) relatively to said gripper base (30), on the other hand.

3. The robot gripper as defined in claim 2,
characterized in that
said transmission (36) has at least one driving gearwheel (34b 34a) each for said displacement device (50) and for said carrying device (40), said two driving gearwheels (34a, 34b) being coupled via a belt transmission (36) to each other and/or to a driving motor (38).

4. The robot gripper as defined in claim 1,
characterized in that
in a first relative end position, said displacement device (50) and said carrying device (40) have been moved such that a distal end of said carrying device (50) is disposed not more than 15 cm, in the longitudinal direction (2) of said gripper, beyond a distal end of said displacement device and, preferably in this first relative end position, said displacement device and said carrying device have been moved to an extent such that the distal end of said displacement device protrudes, in the longitudinal direction of said gripper, beyond the distal end of said carrying device.

5. A robot system, particularly adapted to grasp, transport, and deposit goods in transit (60), more particularly pieces of baggage such as suitcases and traveling bags, comprising
a robot base (8), which is stationary or is displaceable via a system of rails,
a robot arm (10), which is movable relatively to said robot base (8), a coupling device for coupling a robot gripper (20) being provided at the end of said robot arm,
and
a controlling device for controlling said robot arm (10) and said robot gripper (20)
characterized in that
to the coupling device of said robot arm (10) there is attached a robot gripper (20) as defined in claim 1.
